(19) United States
(12) Patent Application Publication
(10) Pub. No.: US 2013/0127180 A1
(43) Pub. Date: May 23, 2013

(54) MOTOR VEHICLE DOOR

(71) Applicant: GM Global Technology Operations LLC, Detroit, MI (US)

(72) Inventors: Andreas Heberer, Mainz (DE); Peter Eduard Schuessler, Hoesbach (DE); Wadim Wilenz, Offenbach (DE)

(73) Assignee: GM GLOBAL TECHNOLOGY OPERATIONS LLC, Detroit, MI (US)

(21) Appl. No.: 13/672,895

(22) Filed: Nov. 9, 2012

(30) Foreign Application Priority Data
Nov. 11, 2011 (DE) 102011118333.0

(51) Int. Cl. E05B 65/12

(52) U.S. Cl. CPC E05B 81/80
USPC 292/2

(57) ABSTRACT

A motor vehicle door having a movable lock is provided. The movable lock can lock or release the door opener. The motor vehicle door can also include an electrically operated actuator for driving the movement of the lock, and at least one solar cell which supplies the actuator with energy.

### CROSS-REFERENCE TO RELATED APPLICATION

This application claims priority to German Patent Application No. 10 2011 118 333.0, filed Nov. 11, 2011, which is incorporated herein by reference in its entirety.

### TECHNICAL FIELD

This application pertains to a motor vehicle door with a movable lock for locking or releasing the door opener.

### BACKGROUND

For a long time it has been usual to couple a lock mechanically, possibly via a Bowden cable, to actuating elements on the inner and outer side of a motor vehicle door in order to lock or unlock the door. The components of such a mechanical coupling must be adapted to the distances between lock and actuating elements and the space available for their installation, which if it does not prevent the use of identical components in the doors of different vehicle models, makes this appreciably difficult. In addition, the installation of such a mechanical coupling is time-consuming and accordingly costly.

It has therefore been proposed to replace the established mechanical coupling by an electrical coupling. An electrical actuator of such a coupling and switches controlling the actuator on the door inner and outer side can be used identically in many models; however, length and course of a wiring between switches and actuator is different from one model to another. One problem with electrical door closing systems is the required operating safety; it must be ensured that the doors of a vehicle can still be opened and closed when the electrical on-board power supply of such a vehicle has largely failed.

Known from DE 103 60 418 A1 is a motor vehicle closing system comprising an electrical actuator for locking and unlocking a motor vehicle door in which the actuator can be operated both with energy from the motor vehicle on-board power supply and from solar cells. The on-board power supply can provide the energy required for operation of the actuator if the solar cells are not in a position to do this.

Accordingly, it is desirable to provide a motor vehicle door with an electrically driven lock, which also has a high operating safety in the event of an accident. In addition, other objects, desirable features and characteristics will become apparent from the subsequent summary and detailed description, and the appended claims, taken in conjunction with the accompanying drawings and this background.

### SUMMARY

According to various exemplary embodiments, provided is a motor vehicle door having a movable lock for locking or releasing the door opener and an electrical actuator for driving the movement of the lock, in which the door has at least one solar cell supplying the actuator with energy. The solar cell can provide the energy required for unlocking the door even when lines between the door and the vehicle battery are destroyed by an accident.

The solar cell is generally integrated in a handle of the door. Since the handle is generally located in the vicinity of the lock, the length of a wiring between solar cell and actuator and consequently the rise of its damage in the event of an accident can be minimized. In addition, a solar cell integrated in a handle can be wired without additional openings being required for this in an outer skin of the door carrying the handle.

In the simplest case, the at least one solar cell can be the only energy source of the actuator. In one exemplary embodiment, a transmitter is additionally provided via which electrical drive energy for the actuator can be fed into the door. It can thus be eliminated that in cases of frequent actuation and weak light, sufficient energy is not provided for operation of the actuator.

The transmitter generally only allows the transmission of energy in one direction, from outside to the door.

In order to enable actuation of the lock even with a lack of ambient light, an intermediate storage device should be provided which can be charged via the solar cell and in one example, if present, also via the transmitter.

The capacity of this intermediate storage device should be sufficient for at least a single actuation of the lock.

In order to obtain the most extensive possible functional safety even in the event of damage to the door, the intermediate storage device with the actuator is in one example, combined in a compact assembly mounted in the door.

Of the generally plurality of side doors of a motor vehicle, generally each individual one is configured as described above.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a view of a motor vehicle according to the various teachings of the present disclosure;

FIG. 2 shows a partially cutaway view of a door of the vehicle from FIG. 1;

FIG. 3 shows a circuit diagram of the closing system of the door; and

FIG. 4 shows another exemplary embodiment of the closing system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

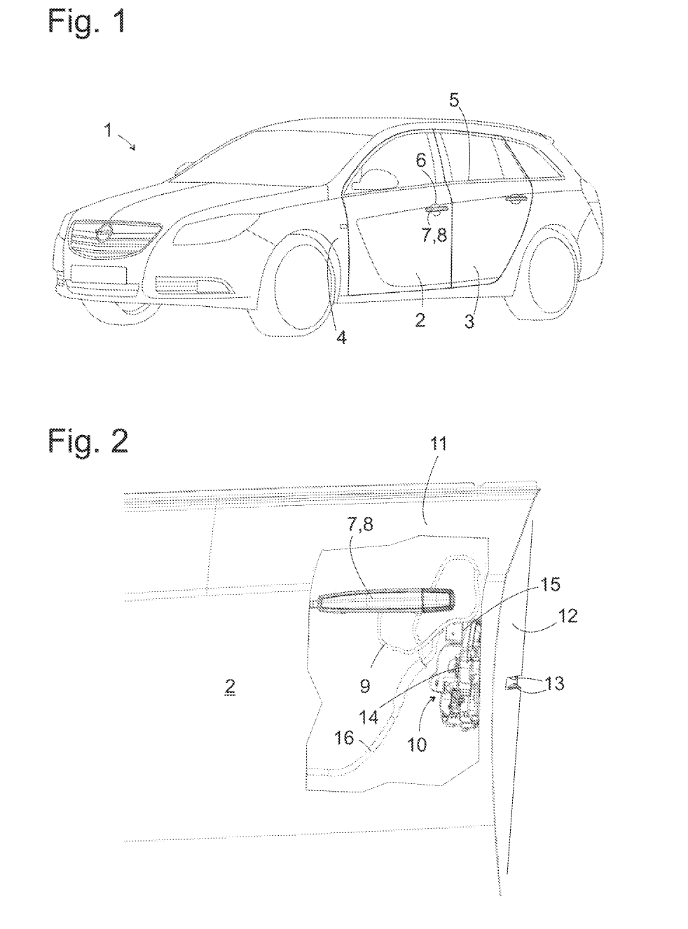

The motor vehicle 1 shown in perspective view in FIG. 1 has right and left side doors, here front doors 2 and rear doors 3. The doors 2, 3 are each pivotably hinged to a bodywork substructure concealed below a front fender 4 or a B pillar extending between the doors 2, 3. The doors 2, 3 usually each have a movable bolt, not visible in FIG. 1, on their rearward flank, which in the locked position, engages in a catch fixed to the bodywork, on the B pillar or on a rear edge of the bracket.

The outer surfaces of the doors 2, 3 are each formed in one piece from metal panels below a belt line 5 of the bodywork. On both sides of a handle recess 6, these door panels each have openings concealed by a door handle 7 spanning the handle recess 6, by which means the door handle 7 is anchored on the door panel and optionally a support structure disposed behind the door panel in the interior of the door 2 or 3.

The outer surfaces of the handles 7 are substantially filled by solar cells 8.

FIG. 2 shows an enlarged detailed view of the front door 2, in which a part of the door panel is cut away around the door handle 7 in order to be able to show elements inside the door 2. An electrical line 9 extends from the solar cells 8 of the door handle 7 through the openings in the door panel to a door closing assembly 10, which is mounted on a rearward narrow side 12 of the door 2 facing the B pillar, which is largely covered by the door panel 11 in the figure. In a notch on the narrow side 12, tips of bolts 13 which are movable with respect to one another are visible, which in the closed position of the door act on a catch of the B pillar. The movement of the bolts 13 is driven by an electrical actuator 14 of the assembly 10. The assembly 10 further comprises a rechargeable battery or supercapacitor 15, which is charged by the solar cell 8 via the electrical line 9 and provides drive energy for the electrical actuator 14. The rechargeable battery 15 is further connected to the on-board power supply of the vehicle via another electrical line 16 so that in normal operation, the electrical actuator 14 is not dependent on the energy of the solar cell 8 for its function.

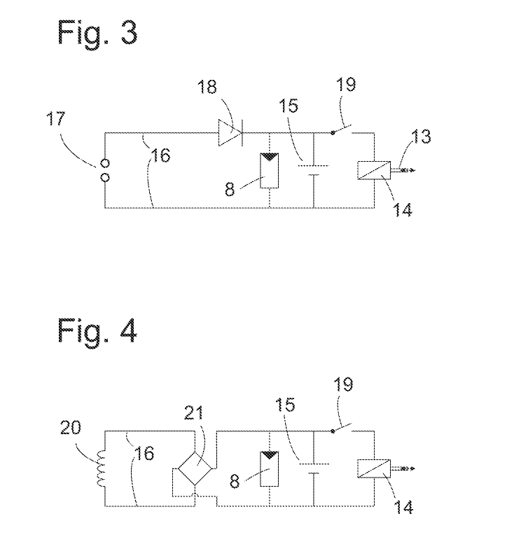

FIG. 3 shows a schematic circuit diagram of the closing system of the door 2 or 3. A drawn-out plug-in connector 17 is provided on a front flank of the door 2, adjacent to the door hinge, in order to make a galvanic connection to the on-board power supply of the motor vehicle. The solar cell 8, the rechargeable battery 15 and the electrical actuator 14 are each connected to the plug-in connector 17 in parallel with one another. A diode 18 which is disposed in one of the cores of the line 16 can prevent any discharging of the rechargeable battery 15 via the on-board power supply, if a short-circuit occurs there as a result of an accident.

In normal operation the on-board power supply is continuously in contact with the terminals of the rechargeable battery 15 via the diode 18 and maintains a charging state of the rechargeable battery 15 in which its energy content is sufficient for one or more actuations of the actuator 14. The actuator 14 in each case adjusts the lock 13 from a release into a locking position and back when a switch 19 on the outer door handle 7 or on a handle on the inner side of the door 2,3 is actuated. If the vehicle battery fails and cannot provide the required operating voltage, the vehicle cannot be started. Nevertheless, an opening and closing of the doors 2, 3 remains possible since in this case the solar cells 8 of each door 2 or 3 can provide for the necessary charging of the rechargeable battery 15.

The galvanic connection between actuator 14 and on-board power supply of FIG. 3 via the plug-in connector 17, which possibly needs to be laid at some expense and requires protection from mechanical and climatic influences, can be replaced by various other techniques for energy transmission, in one example, by an inductive coupling, as shown in FIG. 4. Here a receiver coil 20 of the door closing system cooperates with a transmitter coil, which is mounted fixed to the bodywork on the bracket and is supplied with alternating current in normal operation from the on-board power supply in order to induce an alternating voltage in the receiver coil 20. This charges the rechargeable battery 15 via a rectifier 21. Any discharging of the rechargeable battery 15 to the on-board power supply is eliminated here by the rectifier 21, which similarly to a valve, only allows energy transmission in one direction, from the receiver coil 20 to the rechargeable battery 15.

A rear door of the vehicle 1 (concealed in FIG. 1) can be equipped with a closing assembly 10 and a solar cell 8 which supplies this.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A motor vehicle door, comprising:
a movable lock for locking or releasing an opener of the motor vehicle door; and
an electrically operated actuator that drives the movement of the lock,
wherein the motor vehicle door has at least one solar cell that supplies the actuator with energy.

2. The motor vehicle door according to claim 1, wherein the at least one solar cell is integrated in a handle of the door.

3. The motor vehicle door according to claim 2, further comprising a transmitter via which electric drive energy is supplied to the actuator.

4. The motor vehicle door according to claim 3, wherein the transmitter is only effective in one direction.

5. The motor vehicle door according to claim 4, further comprising an intermediate storage system, which can be charged via the at least one solar cell.

6. The motor vehicle door according to claim 5, wherein the capacity of the intermediate storage device is sufficient for actuating the lock at least once.

7. The motor vehicle door according to claim 5, wherein the intermediate storage device with the actuator is combined in an assembly mounted in the door.

8. A motor vehicle, comprising:
a plurality of side doors, each of the side doors including:
a movable lock for locking or releasing an opener of the respective one of the plurality of doors;
an electrically operated actuator that drives the movement of the lock; and
at least one solar cell that supplies the actuator with energy,
wherein the at least one solar cell is integrated in a handle of the door.

9. The motor vehicle according to claim 8, further comprising a transmitter via which electric drive energy is supplied to the actuator.

10. The motor vehicle according to claim 9, wherein the transmitter is only effective in one direction.

11. The motor vehicle according to claim 10, further comprising an intermediate storage system, which can be charged via the at least one solar cell.

12. The motor vehicle according to claim 11, wherein the capacity of the intermediate storage device is sufficient for actuating the lock at least once.

13. The motor vehicle according to claim 11, wherein the intermediate storage device with the actuator is combined in an assembly mounted in the door.
